(19) United States
(12) Patent Application Publication
(10) Pub. No.: US 2024/0147558 A1
(43) Pub. Date: May 2, 2024

(54) MULTI-LINK INFORMATION ELEMENT WITH MILLIMETER WAVE (MMWAVE) LINK

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/384,818

(22) Filed: Oct. 27, 2023

Related U.S. Application Data
(60) Provisional application No. 63/381,382, filed on Oct. 28, 2022.

(51) Int. Cl. H04W 76/15

(52) U.S. Cl. CPC H04W 76/15; H04W 72/0453

(57) ABSTRACT

Embodiments of a method and apparatus for wireless communications are disclosed. In an embodiment, a wireless multi-link device (MLD) includes a controller configured to generate a frame that includes a multi-link (ML) information element (IE), where the ML IE includes at least one profile of at least one millimeter wave (mmWave) link between the wireless MLD and a second wireless MLD, and a wireless transceiver configured to transmit the frame to the second wireless MLD through a non-mmWave link between the wireless MLD and the second wireless MLD.

### CROSS-REFERENCE TO RELATED APPLICATIONS

This application is entitled to the benefit of U.S. Provisional Patent Application Ser. No. 63/381,382, filed on Oct. 28, 2022, the contents of which are incorporated by reference herein.

### BACKGROUND

In multi-link communications, an access point (AP) multi-link device (MLD) can transmit various types of information using different transmission techniques to a non-AP MLD. For example, a wireless AP MLD may wirelessly transmit data to one or more wireless stations in a non-AP MLD through one or more wireless communications links, such as a millimeter wave (mmWave) link. To facilitate the proper data transmission within a multi-link communications system having an mmWave link, there is a need for multi-link communications technology that can efficiently convey communications signaling information, for example, information related to data, communications links, and/or multi-link devices (e.g., operation and/or capability parameters of multi-link devices) within the multi-link communications system.

### SUMMARY

Embodiments of a method and apparatus for wireless communications are disclosed. In an embodiment, a wireless multi-link device (MLD) includes a controller configured to generate a frame that includes a multi-link (ML) information element (IE), where the ML IE includes at least one profile of at least one millimeter wave (mmWave) link between the wireless MLD and a second wireless MLD, and a wireless transceiver configured to transmit the frame to the second wireless MLD through a non-mmWave link between the wireless MLD and the second wireless MLD. Other embodiments are also disclosed.

In an embodiment, the frame further includes an element that defines Basic Service Set (BSS) information of the non-mmWave link between the wireless MLD and the second wireless MLD.

In an embodiment, no inheritance of the element is applied to the at least one profile of the at least one mmWave link.

In an embodiment, the at least one profile of the at least one mmWave link includes at least one per station (STA) profile of the at least one mmWave link.

In an embodiment, the at least one per STA profile of the at least one mmWave link does not inherit the element.

In an embodiment, the controller is further configured to set a non-inheritance subfield of the at least one per STA profile to a predefined value to indicate that no inheritance is applied to the at least one per STA profile.

In an embodiment, an inheritance of the element is applied to the at least one profile of the at least one mmWave link.

In an embodiment, the at least one profile of the at least one mmWave link includes at least one per station (STA) profile of the at least one mmWave link.

In an embodiment, the inheritance is not applied to information that is not understandable by an Ultra High Reliability (UHR) STA.

In an embodiment, the at least one profile of the at least one mmWave link between the wireless MLD and the second wireless MLD includes profiles of mmWave links between the wireless MLD and the second wireless MLD, and a second profile of a first mmWave link between the wireless MLD and the second wireless MLD inherits an element in a first profile of a first mmWave link between the wireless MLD and the second wireless MLD.

In an embodiment, the wireless MLD includes an access point (AP) MLD that includes a wireless AP, the wireless AP includes the controller and the wireless transceiver, and the second wireless MLD includes a non-AP MLD that includes a non-AP station (STA).

In an embodiment, the frame includes an association response frame.

In an embodiment, the non-mmWave link includes one of a 2.4 Gigahertz (GHz) link, a 5 GHz link, or a 6 GHz link, and the mmWave link includes a 45 GHz link or a 60 GHz link.

In an embodiment, the wireless MLD is compatible with an Institute of Electrical and Electronics Engineers (IEEE) 802.11 protocol.

In an embodiment, a wireless access point (AP) of an AP multi-link device (MLD) includes a controller configured to generate a frame that includes a multi-link (ML) information element (IE), where the ML IE includes at least one Per station (STA) profile of at least one millimeter wave (mmWave) link between the AP MLD and a non-AP MLD, where the mmWave link includes a 45 Gigahertz (GHz) link or a 60 GHz link, and a wireless transceiver configured to transmit the frame to the non-AP MLD through a non-mmWave link between the AP MLD and the non-AP MLD, where the non-mmWave link includes one of a 2.4 GHz link, a 5 GHz link, or a 6 GHz link.

In an embodiment, the frame further includes an element that defines Basic Service Set (BSS) information of the non-mmWave link between the AP MLD and the non-AP MLD, and no inheritance of the element is applied to the at least one Per STA profile of the at least one mmWave link.

In an embodiment, the controller is further configured to set a non-inheritance subfield of the at least one per STA profile to a predefined value to indicate that no inheritance is applied to the at least one per STA profile.

In an embodiment, the frame further includes an element that defines Basic Service Set (BSS) information of the non-mmWave link between the AP MLD and the non-AP MLD, and an inheritance of the element is applied to the at least one profile of the at least one mmWave link.

In an embodiment, the at least one Per STA profile of the at least one mmWave link between the AP MLD and the non-AP MLD includes Per STA profiles of mmWave links between the AP MLD and the non-AP MLD, and a second Per STA profile of a first mmWave link between the AP MLD and the non-AP MLD inherits an element in a first Per STA profile of a first mmWave link between the AP MLD and the non-AP MLD.

In an embodiment, a method for wireless communications involves at a first wireless multi-link device (MLD), generating a frame that includes a multi-link (ML) information element (IE), where the ML IE includes at least one profile of at least one millimeter wave (mmWave) link between the first wireless MLD and a second wireless MLD, and from the first wireless MLD, transmitting the frame to the second wireless MLD through a non-mmWave link between the first wireless MLD and the second wireless MLD.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system in accordance with an embodiment of the invention.

FIG. 2 depicts a multi-link communications system with multiple non-mmWave links.

FIG. 3 depicts an example format of the frame body of an association response frame being transmitted in a non-mmWave link between an AP of an AP MLD and a STA of a non-AP MLD of the multi-link communications system depicted in FIG. 2.

FIG. 4 depicts a multi-link communications system in accordance with an embodiment of the invention.

FIG. 5 depicts a multi-link communications system in accordance with an embodiment of the invention.

FIG. 6 depicts an example format of the frame body of an association response frame being transmitted in a non-mmWave link between an AP of an AP MLD and a STA of a non-AP MLD of the multi-link communications system depicted in FIG. 5.

FIG. 7 depicts a wireless device in accordance with an embodiment of the invention.

FIG. 8 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Institute of Electrical and Electronics Engineer (IEEE) 802.11 communication protocol.

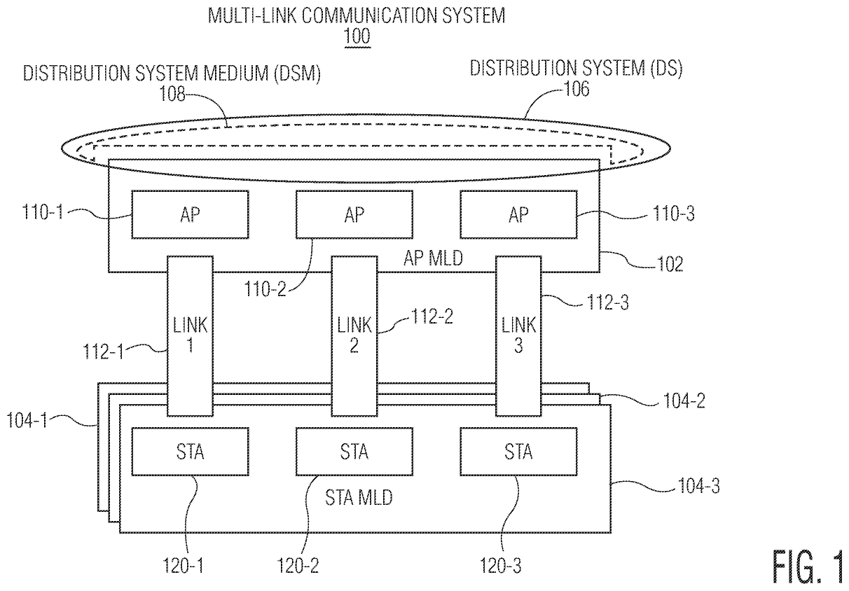

FIG. 1 depicts a multi-link (ML) communications system 100 in accordance with an embodiment of the invention. In the embodiment depicted in FIG. 1, the multi-link communications system includes at least one AP multi-link device (MLD) 102, and one or more non-AP multi-link devices, which are, for example, implemented as station (STA) MLDs 104-1, 104-2, 104-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one wireless local area network (WLAN) communications protocol (e.g., at least one IEEE 802.11 protocol). For example, the APs 110-1, 110-2, 110-3 may be wireless APs compatible with at least one WLAN communications protocol (e.g., at least one IEEE 802.11 protocol).

In some embodiments, an AP MLD (e.g., the AP MLD 102) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 110-1, 110-2, 110-3 of the AP MLD 104 operates in different frequency bands. For example, at least one of the APs 110-1, 110-2, 110-3 of the AP MLD 104 operates in an Extremely High Frequency (EHF) band or the “millimeter wave (mmWave)” frequency band. In some embodiments, the mmWave frequency band is a frequency band between 20 Gigahertz (GHz) and 300 GHz. For example, the mmWave frequency band is a frequency band above 45 GHz, e.g., a 60 GHz frequency band. For example, the AP 110-1 may operate at 6 Gigahertz (GHz) band (e.g., in a 320 MHz (one million hertz) Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 60 GHz band (e.g., a 160 MHz BSS operating channel or other suitable BSS operating channel). In the embodiment depicted in FIG. 1, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to a wireless AP MLD, such as, the AP MLD 102. For example, the STA MLD 104-1 (e.g., at least one of the non-AP STAs 120-1, 120-2, 120-3) may be implemented in a laptop, a desktop personal computer (PC), a mobile phone, or other communications device that supports at least one WLAN communications protocol. In some embodiments, the STA MLD and its affiliated STAs 120-1, 120-2, 120-3 are compatible with at least one IEEE 802.11 protocol. In some embodiments, each of the non-AP STAs 120-1, 120-2, 120-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface. In some embodiments, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 104-1 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. For example, the STA 120-1 may operate at 6 GHz band (e.g., in a 320 MHz (one million hertz) BSS operating channel or other suitable BSS operating channel), the STA 120-2 may operate at 5 GHz band (e.g., a 160 MHz BSS operating channel or other suitable BSS operating channel), and the STA 120-3 may operate at 60 GHz band (e.g., a 160 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 or 104-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. The communications links in the multi-link communications system may include multiple mmWave links and one non-mmWave link, multiple mmWave links and multiple non-mmWave links, one mmWave link and multiple non-mmWave links, or one mmWave link and one non-mmWave link. For example, in the embodiment depicted in FIG. 1, the communications links 112-1, 112-2, 112-3 between the AP MLD and the STA MLD 104-1 involve at least one mmWave link. For example, the communications links 112-1, 112-2, 112-3 between the AP MLD 102 and the STA MLD 104-1 include an mmWave link (e.g., a 45/60 GHz link) between an AP of the AP MLD 102 and an STA of the STA MLD 104-1 operating in an mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, 112-3 between the AP MLD 102 and the STA MLD 104-1 include two mmWave links (e.g., 45/60 GHz links) between APs of the AP MLD 102 and STAs of the STA MLD 104-1 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band). The control and management of an mmWave link, for example, a 45 GHz/60 GHz link may be performed in a non-mmWave link, for example, a 2.4 GHz, 5 GHz, or 6 GHz link. For example, the association of a non-AP MLD with an mmWave link can be done through a non-mmWave MHz link. However, beaconing and channel switch can be challenging for a MLD system with one or more mmWave links.

A basic Multi-Link information element (IE) can be used in Beacon, (Re)Association Request, (Re)Association Response, and/or Multi-Link Probe Response etc. Probe Request Multi-link (ML) information element (IE) can be used in Multi-Link Probe Request. Reconfiguration Multi-link (ML) information element (IE) can be used by an AP MLD to announce the AP removal. Tunneled Direct Link Setup (TDLS) Multi-link (ML) information element (IE) can be used for TDLS establishment between a non-AP MLD and a STA that is not affiliated with a non-AP MLD. Priority Access Multi-link (ML) information element (IE) can be used for announcing the Enhanced Distributed Channel Access (EDCA) parameters for an EPCS (emergency preparedness communications service) STA.

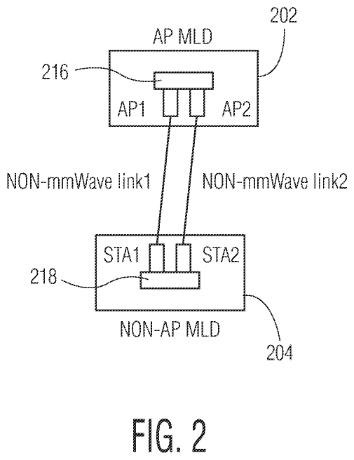

FIG. 2 depicts a multi-link (ML) communications system 200 with multiple non-mmWave links. In the embodiment depicted in FIG. 2, the ML communications system 200 includes an AP MLD 202, which includes a common MAC controller 216 and two wireless APs AP1, AP2, and a non-AP MLD 204, which includes a common MAC controller 218 and two wireless STAs STA1, STA2. The common MAC controller 216 may implement upper layer MAC functionalities (e.g., beaconing, association establishment, reordering of frames, etc.) of the AP MLD 202 and a link specific part of the AP MLD 202, i.e., AP1, AP2, may implement lower layer MAC functionalities (e.g., backoff, frame transmission, frame reception, etc.) of the AP MLD 202. The common MAC controller 218 may implement upper layer MAC functionalities (e.g., association establishment, reordering of frames, etc.) of the non-AP MLD 204 and a link specific part of the non-AP MLD 204, i.e., STA1, STA2, may implement lower layer MAC functionalities (e.g., backoff, frame transmission, frame reception, etc.) of the non-AP MLD 204. In the embodiment depicted in FIG. 2, a non-mmWave link (e.g., a 2.4/5/6 GHz band link) is between AP1 and STA1, which both operate in a non-mmWave frequency band (e.g., a 2.4 GHz, 5 GHz, or 6 GHz frequency band) and are capable of non-mmWave communications, and a non-mmWave link (e.g., a 2.4/5/6 GHz band link) is between AP2 and STA2, which both operate in a non-mmWave frequency band (e.g., a 2.4 GHz, 5 GHz, or 6 GHz frequency band) and are capable of non-mmWave communications. The basic multi-link (ML) information element (IE) in (Re)Association request/response, multi-link probe response allows the inheritance of reporting link's Per-STA Profile by reported link. The inheritance may be based on the elements of frame being transmitted in the reported link and whether the content of an element with an element ID in the reported link is the same as the content of the element with element ID in the reporting link.

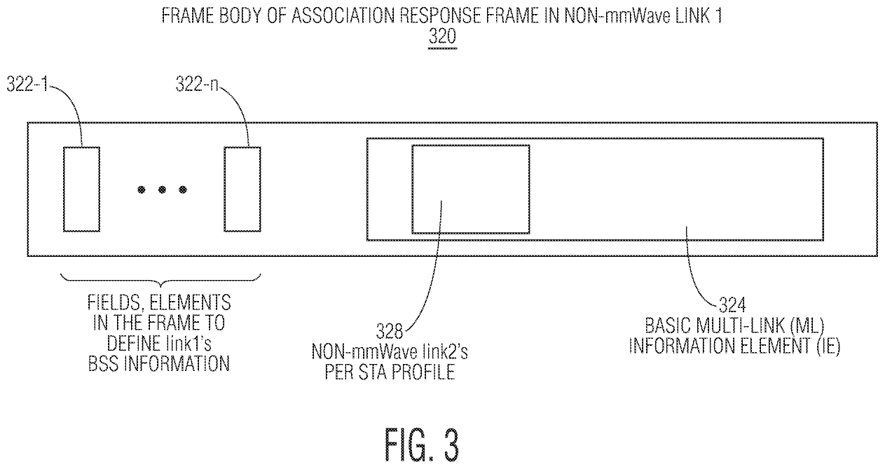

FIG. 3 depicts an example format of the frame body of an association response frame 320 being transmitted in the non-mmWave link1 between AP1 of the AP MLD 202 and STA1 of the non-AP MLD 204 of the multi-link communications system 200 depicted in FIG. 2. As depicted in FIG. 3, the frame body of the association response frame 320 includes fields and elements 322-1, . . . , 322-n, where n is a positive integer, which define the non-mmWave link 1's BSS information, and a basic multi-link (ML) information element (IE) 324, which includes the non-mmWave link2's Per STA Profile 328. For example, in the association response frame transmitted in the non-mmWave link1 (reporting link) with Per STA Profile of the non-mmWave link2 (reported link), if the non-mmWave link2's EDCA Parameter Set element has the same content as the non-mmWave link1's EDCA Parameter Set element, the Per STA Profile of the non-mmWave link2 will not carry EDCA Parameter Set element. The non-mmWave Link1's EDCA Parameter Set element will be inherited. For example, in the association response frame transmitted in the non-mmWave link1 (reporting link) with Per STA Profile of the non-mmWave link2 (reported link), if the non-mmWave link2 has no broadcast Target Wake Time (TWT) schedule and the non-mmWave link1 has several broadcast TWT schedules, the Per STA Profile of the non-mmWave link2 will not carry TWT element and the Non-Inheritance in Per STA Profile of the non-mmWave link2 will carry the Element ID of TWT element.

For mmWave links, there may be no association request/response defined in an mmWave link if the multi-link association, probing of the mmWave link is done through a non-mmWave link. In addition, there may not be a reference frame to figure out the elements of a Per STA Profile of an mmWave link as the reported link. Generally, the elements of an mmWave link have no similarity as the elements of a non-mmWave link. For example, a non-mmWave link (e.g., a 5 GHz link) has High Throughput (HT)/Very High Throughput (VHT)/High Efficiency (HE)/Extremely High Throughput (EHT) Capabilities, HT/VHT/HE/EHT Operation elements that are not useful in an mmWave link. If the inheritance is applied, the non-inheritance element can be quite lengthy. In some embodiments, when the inheritance is applied between when the inheritance is applied between information (the elements other than an ML element being carrying in the frame) of a reporting link (i.e., the link (e.g., a non-mmWave link) in which a frame is transmitted) and a Per STA Profile of a reported link (i.e., the link (e.g., a mmWave link) whose information is within the frame), the Per STA Profile of the reported link includes at least some elements of the Per STA Profile of the reporting link, e.g., the BSS operation element of the reported link (e.g., mmWave Operation element) since the different links need to at least have the different operating channels.

In some embodiments, no inheritance is applied to Per STA Profile of an mmWave link. In some embodiments, when the inheritance is not applied between the information (the elements other than an ML element being carrying in the frame) of a reporting link (i.e., the link (e.g., a non-mmWave link) in which a frame is transmitted) and a Per STA profile of a reported link (i.e., the link (e.g., a mmWave link) whose information is within the frame), the elements of the reporting link has no influence to the elements in Per STA profile of the reported link. For example, the EDCA Parameters Set element with the same value needs to be carried in the frame for the reporting link and in the Per STA Profile of the reported link. In a first option, implicit inheritance disabling is implemented. For example, the Per STA Profile of an mmWave link as the reported link does not apply inheritance from the elements of a reporting non-mmWave link in (Re)Association Request/Response, Multi-Link Probe Response. In a second option, explicit inheritance disabling is implemented through Complete Profile reusing. For example, Complete Profile is set to 0 to avoid inheritance. In a third option, explicit inheritance disabling is implemented through a new indication. For example, a new non-inheritance subfield is defined in a STA Control field where if a Non-Inheritance subfield of a Per STA Profile is 1, the inheritance will not be applied to the Per STA Profile with full information.

In some embodiments, inheritance is applied to Per STA Profile of an mmWave Link. In some embodiments, when the inheritance is applied between the information(the elements other than an ML element being carrying in the frame) of a reporting link (i.e., the link (e.g., a non-mmWave link) in which a frame is transmitted) and a Per STA Profile of a reported link (i.e., the link (e.g., a mmWave link) whose information is within the frame), if the element that is applied to both the reporting link and the reported link has the same content for the reporting link and reported link, the Per STA profile of the reported link will not carry the element. In some embodiments, a STA that receives a management frame addressed to it ignores/skips an element that the STA does not understand. Ultra High Reliability (UHR) specification clarifies the elements that are not understood by a UHR STA/AP. Such elements include, for example, HT/VHT/HE/EHT Capabilities, HT/VHT/HE/EHT Operation elements since a UHR STA does not support HT/VHT/HE/EHT, multi-user (MU) EDCA Parameter Set element if TB (Trigger Based) physical layer protocol data unit (PPDU) is not supported by the UHR specification, fast initial link setup (FILS) Related elements, and/or TPE (Transmit Power Envelope) element. UHR specification may define a dummy Association Request/Response and/or ML Probe Response. In some embodiments, the Per STA Profile of an mmWave link as a reported link applies inheritance from the element of a reporting non-mmWave link in Association Request/Response, Multi-Link Probe Response. However, in some embodiments, the inheritance is not applied to the elements that are not understandable or understood by a UHR STA, not in respective dummy Association Request/Response and/or ML Probe Response of an mmWave link. In one embodiment, the Element ID (and Element ID Extension if exists) of an element in one of Association Request/Response, Multi-Link Probe Response transmitted in a non-mmWave link and is not inherited by the mmWave link as a reported link is not carried in a non-Inheritance element of the Per STA Profile related to the mmWave link. In one embodiment, the Element ID (and Element ID Extension if exists) of an element in one of Association Request/Response, Multi-Link Probe Response transmitted in a non-mmWave link and is not carried in the respective dummy frame in the mmWave link is not carried in a non-Inheritance element related to the mmWave link. As an example, since the EHT Operation element is not understood by an mmWave AP/STA, the EHT Operation element in Association Response frame will not be inherited by the Per STA Profile related to a mmWave link and will not be carried a non-Inheritance element of the Per STA Profile related to the mmWave link.

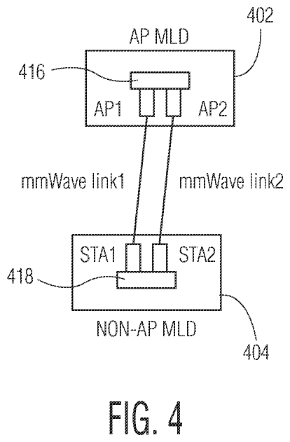

FIG. 4 depicts a multi-link (ML) communications system 400 in accordance with an embodiment of the invention. In the embodiment depicted in FIG. 4, the ML communications system 400 includes an AP MLD 402, which includes a common MAC controller 416 and two wireless APs AP1, AP2, and a non-AP MLD 404, which includes a common MAC controller 418 and two wireless STAs STA1, STA2. In some embodiments, the common MAC controller 416 implements upper layer MAC functionalities (e.g., beaconing, association establishment, reordering of frames, etc.) of the AP MLD 402 and a link specific part of the AP MLD 402, i.e., API, AP2, implements lower layer MAC functionalities (e.g., backoff, frame transmission, frame reception, etc.) of the AP MLD 402. In some embodiments, the common MAC controller 418 implements upper layer MAC functionalities (e.g., association establishment, reordering of frames, etc.) of the non-AP MLD 404 and a link specific part of the non-AP MLD 404, i.e., STA1, STA2, implements lower layer MAC functionalities (e.g., backoff, frame transmission, frame reception, etc.) of the non-AP MLD 404. The ML communications system 400 depicted in FIG. 4 is an embodiment of the ML communications system 100 depicted in FIG. 1. However, the ML communications system 100 depicted in FIG. 1 is not limited to the embodiment shown in FIG. 4. For example, the AP MLD 402 depicted in FIG. 4 is an embodiment of the AP MLD 102 depicted in FIG. 1. However, the AP MLD 102 depicted in FIG. 1 is not limited to the embodiment shown in FIG. 4. In addition, the non-AP MLD 404 depicted in FIG. 4 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 4. In the embodiment depicted in FIG. 4, a non-mmWave link (e.g., a 2.4/5/6 GHz band link), which is referred to the non-mmWave link1, is between AP1 and STA1, which both operate in a non-mmWave frequency band (e.g., a 2.4 GHz, 5 GHz, or 6 GHz frequency band) and are capable of non-mmWave communications, and an mmWave link (e.g., a 45 GHz link or a 60 GHz link), which is referred to the mmWave link2, is between AP2 and STA2, which both operate in an mmWave frequency band (e.g., a 45 GHz or 60 GHz frequency band) and are capable of mmWave communications. Although the AP MLD 402 is shown in FIG. 4 as including two APs, other embodiments of the AP MLD 402 may include fewer than two APs or more than two APs. In addition, although the non-AP MLD 404 is shown in FIG. 4 as including two non-AP STAs, other embodiments of the non-AP MLD 404 may include fewer than two non-AP STAs or more than two non-AP STAs.

In some embodiments, no inheritance is applied to Per STA Profile of the mmWave link2. In some embodiments, when the inheritance is not applied between a Per STA profile of the mmWave link2 and the information (the elements other than an ML element being carrying in the frame) of the non-mmWave link1 in a management frame being transmitted in the non-mmWave link1, the elements carried in Per STA profile of the mmWave link2 are not influenced by the elements except the ML element in the frame transmitted in the non-mmWave link1. In some embodiments, the Per STA Profile is the subelement of the ML element. In some embodiments, implicit inheritance disabling is implemented and the Per STA Profile of the mmWave link2 as the reported link does not apply inheritance from the elements of the reporting non-mmWave link1 in (Re)Association Request/Response, Multi-Link Probe Response. In some embodiments, explicit inheritance disabling is implemented by setting a complete Profile to 0 to avoid inheritance. In some embodiments, explicit inheritance disabling is implemented by defining a new non-inheritance subfield in STA Control field where if Non-Inheritance subfield of a Per-STA Profile is 1, the inheritance will not be applied to the Per-STA Profile with full information.

In some embodiments, inheritance is applied to Per STA Profile of the mmWave link2. In some embodiments, when the inheritance is applied between a Per STA profile of the mmWave link2 being carried in an ML element and the information (the elements other than the ML element being carrying in the frame) of the non-mmWave link1 in the frame being transmitted in link1, an element of the mmWave link2 that is same as the element of the non-mmWave link1 will not be carried in the Per STA Profile of the mmWave link2. In some embodiments, a STA that receives a management frame addressed to it ignores/skips an element that the STA does not understand. In some embodiments, a wireless specification (e.g., UHR-mmWave specification) clarifies the elements that are not understood by a UHR STA/AP by listing the related Element ID and Element ID Extension if exists, which include, for example, HT/VHT/HE/EHT Capabilities, HT/VHT/HE/EHT Operation elements since a UHR STA does not support HT/VHT/HE/EHT, multi-user (MU) EDCA Parameter Set element if TB PPDU is not supported by the UHR specification, FILS Related elements, and/or TPE (Transmit Power Envelope) element. In some embodiments, the Per STA Profile of the mmWave link2 as a reported link applies inheritance from the element of a reporting non-mmWave link1 in Association Request/Response, Multi-Link Probe Response being transmitted in the reporting non-mmWave link1. However, in some embodiments, the inheritance is not applied to the elements that are not understood by a UHR STA.

In some embodiments, when a frame carries Per STA Profiles of multiple mmWave links as the reported links in an ML element where each Per STA Profile of a mmWave link carries the full information of the mmWave link, a Per STA Profile of mmWave link in the ML element that is not the first Per STA Profile of mmWave link in the ML element in the frame inherits the Per STA Profile of the first Per STA Profile of the mmWave link in the ML element.

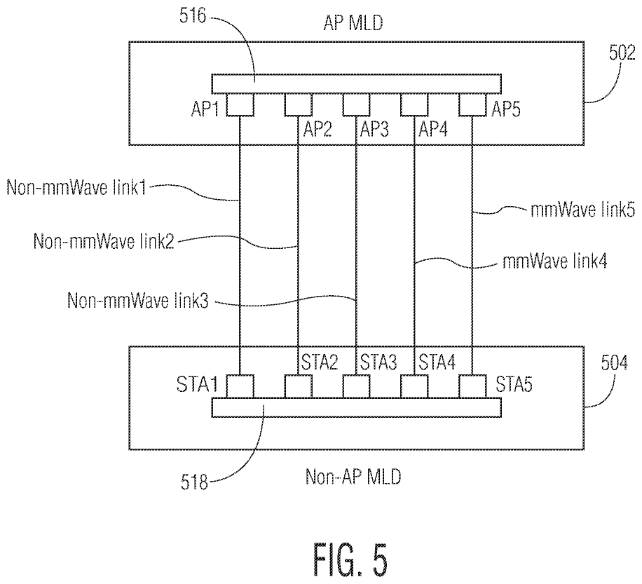

FIG. 5 depicts a multi-link (ML) communications system 500 in accordance with an embodiment of the invention. In the embodiment depicted in FIG. 5, the ML communications system 500 includes an AP MLD 502, which includes a common MAC controller 516 and five wireless APs AP1, AP2, AP3, AP4, AP5 and a non-AP MLD 504, which includes a common MAC controller 518 and five wireless STAs STA1, STA2, STA3, STA4, STA5. In some embodiments, the common MAC controller 516 implements upper layer MAC functionalities (e.g., beaconing, association establishment, reordering of frames, etc.) of the AP MLD 502 and a link specific part of the AP MLD 502, i.e., AP1, AP2, AP3, AP4, APS, implements lower layer MAC functionalities (e.g., backoff, frame transmission, frame reception, etc.) of the AP MLD 502. In some embodiments, the common MAC controller 518 implements upper layer MAC functionalities (e.g., association establishment, reordering of frames, etc.) of the non-AP MLD 504 and a link specific part of the non-AP MLD 504, i.e., STA1, STA2, STA3, STA4, STA5, implements lower layer MAC functionalities (e.g., backoff, frame transmission, frame reception, etc.) of the non-AP MLD 504. The ML communications system 500 depicted in FIG. 5 is an embodiment of the ML communications system 100 depicted in FIG. 1. However, the ML communications system 100 depicted in FIG. 1 is not limited to the embodiment shown in FIG. 5. For example, the AP MLD 502 depicted in FIG. 5 is an embodiment of the AP MLD 102 depicted in FIG. 1. However, the AP MLD 102 depicted in FIG. 1 is not limited to the embodiment shown in FIG. 5. In addition, the non-AP MLD 504 depicted in FIG. 5 is an embodiment of the non-AP MLDs 104-1, 104-2, 104-3 depicted in FIG. 1. However, the non-AP MLDs 104-1, 104-2, 104-3 depicted in FIG. 1 are not limited to the embodiment shown in FIG. 5. In the embodiment depicted in FIG. 5, a non-mmWave link (e.g., a 2.4/5/6 GHz band link), which is referred to as the non-mmWave link1, is between AP1 and STA1, which both operate in a non-mmWave frequency band (e.g., a 2.4 GHz, 5 GHz, or 6 GHz frequency band) and are capable of non-mmWave communications, a non-mmWave link (e.g., a 2.4/5/6 GHz band link), which is referred to as the non-mmWave link2, is between AP2 and STA2, which both operate in a non-mmWave frequency band (e.g., a 2.4 GHz, 5 GHz, or 6 GHz frequency band) and are capable of non-mmWave communications, an mmWave link (e.g., a 45 GHz link or a 60 GHz link), which is referred to the mmWave link3, is between AP3 and STA3, which both operate in an mmWave frequency band (e.g., a 45 GHz or 60 GHz frequency band) and are capable of mmWave communications, an mmWave link (e.g., a 45 GHz link or a 60 GHz link), which is referred to the mmWave link4, is between AP4 and STA4, which both operate in an mmWave frequency band (e.g., a 45 GHz or 60 GHz frequency band) and are capable of mmWave communications, and an mmWave link (e.g., a 45 GHz link or a 60 GHz link), which is referred to the mmWave link5, is between AP5 and STA5, which both operate in an mmWave frequency band (e.g., a 45 GHz or 60 GHz frequency band) and are capable of mmWave communications. Although the AP MLD 502 is shown in FIG. 5 as including five APs, other embodiments of the AP MLD 502 may include fewer than five APs or more than five APs. In addition, although the non-AP MLD 504 is shown in FIG. 5 as including five non-AP STAs, other embodiments of the non-AP MLD 504 may include fewer than five non-AP STAs or more than five non-AP STAs.

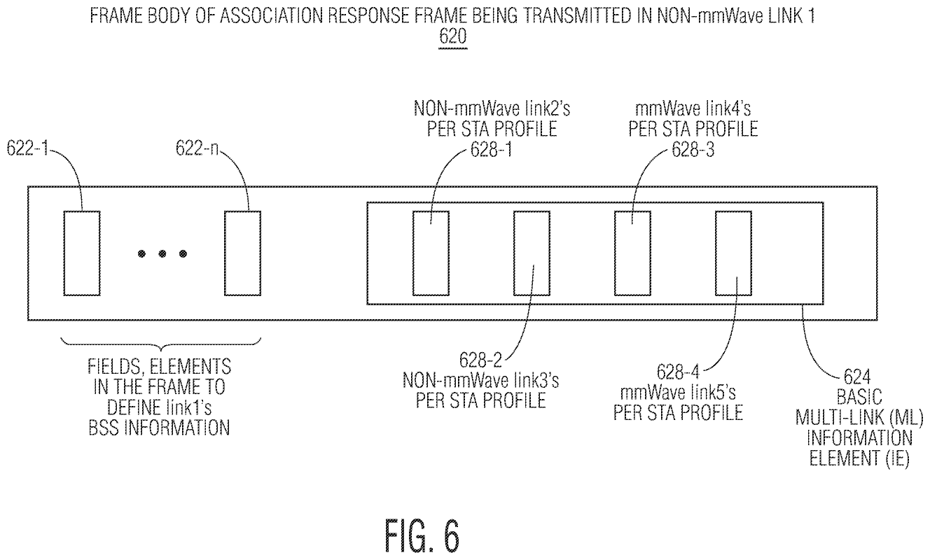

FIG. 6 depicts an example format of the frame body of an association response frame 620 being transmitted in the non-mmWave link1 between AP1 of the AP MLD 502 and STA1 of the non-AP MLD 504 of the multi-link communications system 500 depicted in FIG. 5. In the embodiment depicted in FIG. 6, the frame body of the association response frame 620 includes fields and elements 622-1, . . . , 622-n, where n is a positive integer, which define the non-mmWave link 1's BSS information (e.g., the BSS color information and/or the bandwidth (BW) of the BSS operating channel), and a basic multi-link (ML) information element (IE) 624. Specifically, the basic multi-link (ML) information element (IE) 624 includes the non-mmWave link2's Per STA Profile 628-1, the non-mmWave link3's Per STA Profile 628-2, the mmWave link4's Per STA Profile 628-3, and the mmWave link5's Per STA Profile 628-4. The Per STA Profile of a reported link carries the elements of the reported link as in the respective (dummy) management frame being transmitted in the reported link. One example is in Association Response frame of the non-mmWave link1, the elements in Per STA Profile of the non-mmWave link2 628-1 are the elements as if an Association Response being transmitted in the non-mmWave link2 where the inheritance rules are also applied to elements. The same is applied to the non-mmWave link3's Per STA Profile 628-2. In association Response frame of the non-mmWave link1, the elements in the Per STA Profile 628-3 of the mmWave link4 are the elements as if a dummy Association Response being transmitted in the mmWave link4. In the association response frame, the inheritance is applied as follows: the non-mmWave link2's Per STA Profile 628-1 and the non-mmWave link3's Per STA Profile 628-2 inherit the elements 622-1, . . . , 622-n in the association response frame, the mmWave link4′s Per STA Profile 628-3 does not inherit the elements 622-1, . . . , 622-n in the association response frame, and the mmWave link5's Per STA Profile 628-4 inherits elements in the mmWave Link4's Per STA Profile 628-3. Although the fields of the association response frame 620 are shown in FIG. 6 in certain order, other embodiments of the association response frame may include the same, fewer, or more fields in a different order. In addition, although the frame body of the association response frame 620 is shown in FIG. 6 with certain fields, other embodiments of the association response frame 620 may include fewer or more fields to carry the same, less, or more information.

Some examples of beacons of an mmWave Link are described as follows. In a first option, a light mmWave beacon includes basic multi-link (ML) information element (IE). In some embodiments, a light mmWave beacon transmitted by a mmWave AP includes Reduced Neighbor Report (RNR) element to announce non-mmWave APs and other mmWave APs (if exist) that are affiliated with the same AP MLD as the mmWave AP. With this information, a neighbor mmWave AP can acquire the full information of the mmWave AP through non-mmWave APs. In a second option, a light mmWave beacon does not include the basic multi-link (ML) information element (IE) an RNR element. In a third option, no mmWave Beacon is defined.

Some examples of beacons of a non-mmWave Link are described as follows. In a first option, the beacon of a non-mmWave AP includes a basic multi-link (ML) information element (IE), RNR element and Multiple BSSID (Basic Service Set Identifier) element with basic Multi-link (ML) information element (IE)(s) (if the reporting AP supports Multiple BSSID element) to carry the information of mmWave AP(s) and the AP MLD(s) that the mmWave AP(s) are affiliated with. Other MLDs may acquire the full information of mmWave APs through Multi-Link Probe Request/Response. In a second option, the beacon of a non-mmWave AP includes a basic multi-link (ML) information element (IE), RNR element and Multiple BSSID element with basic Multi-link (ML) information element (IE)(s) (if the reporting AP supports Multiple BSSID element) to carry the information of mmWave AP(s) and the AP MLD(s) that the mmWave AP(s) are affiliated with. The beacon of a non-mmWave AP may also include the full information of each mmWave AP that is affiliated with the same AP MLD as the non-mmWave AP, the full information of each mmWave AP that is affiliated with the same AP MLD as a non-mmWave AP being in the same multiple BSSID AP set as the non-mmWave AP.

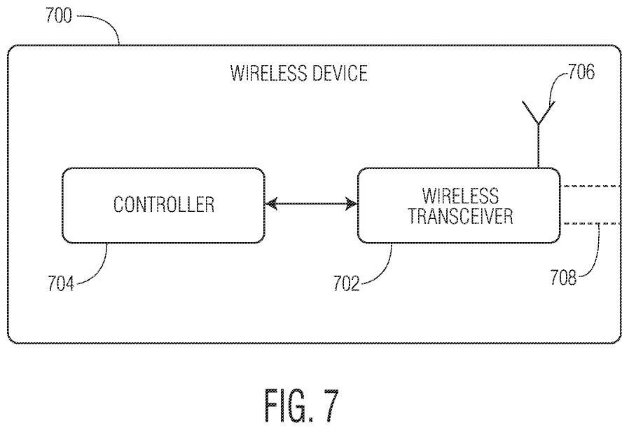

FIG. 7 depicts a wireless device 700 in accordance with an embodiment of the invention. The wireless device 700 can be used in the multi-link communications system 100 depicted in FIG. 1. For example, the wireless device 700 may be an embodiment of the APs 110-1, 110-2, 110-3 or the STAs 120-1, 120-2, 120-3 depicted in FIG. 1, the APs AP1, AP2 or the STAs STA1, STA2 depicted in FIG. 2, the APs AP1, AP2 or the STAs STA1, STA2 depicted in FIG. 4, and/or the APs AP1, AP2, AP3, AP4, AP5 or the STAs STA1, STA2, STA3, STA4, STA5 depicted in FIG. 5. However, the APs 110-1, 110-2, 110-3 or the STAs 120-1, 120-2, 120-3 depicted in FIG. 1, the APs AP1, AP2 or the STAs STA1, STA2 depicted in FIG. 2, the APs AP1, AP2 or the STAs STA1, STA2 depicted in FIG. 4, and/or the APs AP1, AP2, AP3, AP4, AP5 or the STAs STA1, STA2, STA3, STA4, STA5 depicted in FIG. 5 are not limited to the embodiment depicted in FIG. 7. In the embodiment depicted in FIG. 7, the wireless device 700 includes a wireless transceiver 702, a controller 704 operably connected to the wireless transceiver, and at least one antenna 706 operably connected to the wireless transceiver. In some embodiments, the wireless device 700 may include at least one optional network port 708 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 700 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 700 may be compatible with an IEEE 802.11 protocol.

In accordance with an embodiment of the invention, the controller 704 is configured to generate a frame that includes a multi-link (ML) information element (IE), where the ML IE includes at least one profile of at least one millimeter wave (mmWave) link between a wireless MLD to which the wireless device 700 belong and a second wireless MLD, and the wireless transceiver 702 is configured to transmit the frame to the second wireless MLD through a non-mmWave link between the wireless MLD and the second wireless MLD. In some embodiments, the frame further includes an element that defines Basic Service Set (BSS) information of the non-mmWave link between the wireless MLD and the second wireless MLD. In some embodiments, no inheritance of the element is applied to the at least one profile of the at least one mmWave link. In some embodiments, at least one profile of the at least one mmWave link includes at least one per station (STA) profile of the at least one mmWave link. In some embodiments, the at least one per STA profile of the at least one mmWave link does not inherit the element. In some embodiments, the controller is further configured to set a non-inheritance subfield of the at least one per STA profile to a predefined value to indicate that no inheritance is applied to the at least one per STA profile. In some embodiments, an inheritance of the element is applied to the at least one profile of the at least one mmWave link. In some embodiments, the at least one profile of the at least one mmWave link includes at least one per station (STA) profile of the at least one mmWave link. In some embodiments, the inheritance is not applied to information that is not understandable by an Ultra High Reliability (UHR) STA. In some embodiments, the at least one profile of the at least one mmWave link between the wireless MLD and the second wireless MLD includes profiles of mmWave links between the wireless MLD and the second wireless MLD, and a second profile of a first mmWave link between the wireless MLD and the second wireless MLD inherits an element in a first profile of a first mmWave link between the wireless MLD and the second wireless MLD. In some embodiments, the wireless MLD includes an access point (AP) MLD that includes a wireless AP, the wireless AP includes the controller and the wireless transceiver, and the second wireless MLD includes a non-AP MLD that includes a non-AP station (STA). In some embodiments, the frame includes an association response frame. In some embodiments, the non-mmWave link includes one of a 2.4 Gigahertz (GHz) link, a 5 GHz link, or a 6 GHz link, and the mmWave link includes a 45 GHz link or a 60 GHz link. In some embodiments, the wireless MLD is compatible with an Institute of Electrical and Electronics Engineers (IEEE) 802.11 protocol.

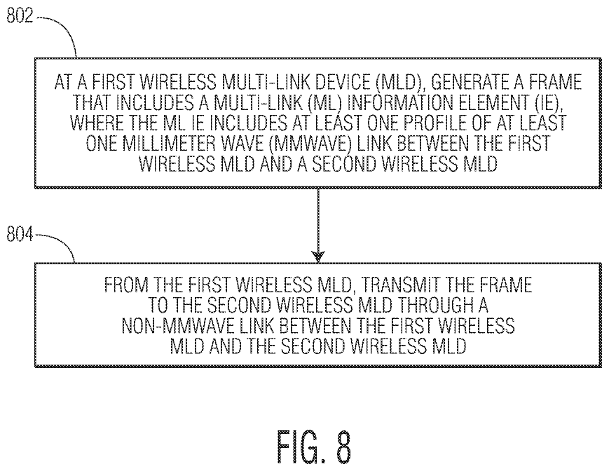

FIG. 8 is a process flow diagram of a method for wireless communications in accordance with an embodiment of the invention. At block 802, at a first wireless multi-link device (MLD), control or management information regarding a millimeter wave (mmWave) link between the wireless MLD and a second wireless MLD is generated. At block 804, from the first wireless MLD, the control or management information regarding the mmWave link is transmitted to the second wireless MLD through the mmWave link or a non-mmWave link between the wireless MLD and the second wireless MLD. In some embodiments, the frame further includes an element that defines Basic Service Set (BSS) information of the non-mmWave link between the first wireless MLD and the second wireless MLD. In some embodiments, no inheritance of the element is applied to the at least one profile of the at least one mmWave link. In some embodiments, the at least one profile of the at least one mmWave link includes at least one per station (STA) profile of the at least one mmWave link. In some embodiments, the at least one per STA profile of the at least one mmWave link does not inherit the element. In some embodiments, the method further includes setting a non-inheritance subfield of the at least one per STA profile to a predefined value to indicate that no inheritance is applied to the at least one per STA profile. In some embodiments, an inheritance of the element is applied to the at least one profile of the at least one mmWave link. In some embodiments, the at least one profile of the at least one mmWave link includes at least one per station (STA) profile of the at least one mmWave link. In some embodiments, the inheritance is not applied to information that is not understandable by an Ultra High Reliability (UHR) STA. In some embodiments, the at least one profile of the at least one mmWave link between the first wireless MLD and the second wireless MLD includes profiles of mmWave links between the first wireless MLD and the second wireless MLD, and where a second profile of a first mmWave link between the first wireless MLD and the second wireless MLD inherits an element in a first profile of a first mmWave link between the first wireless MLD and the second wireless MLD. In some embodiments, the first wireless MLD includes an access point (AP) MLD that includes a wireless AP, where the wireless AP includes the controller and the wireless transceiver, and where the second wireless MLD includes a non-AP MLD that includes a non-AP station (STA). In some embodiments, the frame includes an association response frame. In some embodiments, the non-mmWave link includes one of a 2.4 Gigahertz (GHz) link, a 5 GHz link, or a 6 GHz link, and the mmWave link includes a 45 GHz link or a 60 GHz link. In some embodiments, the first wireless MLD is compatible with an Institute of Electrical and Electronics Engineers (IEEE) 802.11 protocol. The first wireless MLD and/or the second wireless MLD may be the same as or similar to the AP MLD 102 depicted in FIG. 1, the non-AP MLD 104-1, 104-2, or 104-3 depicted in FIG. 1, the AP MLD 202 depicted in FIG. 2, the non-AP MLD 204 depicted in FIG. 2, the AP MLD 402 depicted in FIG. 4, the non-AP MLD 404 depicted in FIG. 4, the AP MLD 502 depicted in FIG. 5, and/or the non-AP MLD 504 depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless multi-link device (MLD) comprising:
a controller configured to generate a frame that comprises a multi-link (ML) information element (IE), wherein the ML IE comprises at least one profile of at least one millimeter wave (mmWave) link between the wireless MLD and a second wireless MLD; and
a wireless transceiver configured to transmit the frame to the second wireless MLD through a non-mmWave link between the wireless MLD and the second wireless MLD.

2. The wireless MLD of claim 1, wherein the frame further comprises an element that defines Basic Service Set (BSS) information of the non-mmWave link between the wireless MLD and the second wireless MLD.

3. The wireless MLD of claim 2, wherein no inheritance of the element is applied to the at least one profile of the at least one mmWave link.

4. The wireless MLD of claim 3, wherein the at least one profile of the at least one mmWave link comprises at least one per station (STA) profile of the at least one mmWave link.

5. The wireless MLD of claim 4, wherein the at least one per STA profile of the at least one mmWave link does not inherit the element.

6. The wireless MLD of claim 5, wherein the controller is further configured to set a non-inheritance subfield of the at least one per STA profile to a predefined value to indicate that no inheritance is applied to the at least one per STA profile.

7. The wireless MLD of claim 2, wherein an inheritance of the element is applied to the at least one profile of the at least one mmWave link.

8. The wireless MLD of claim 7, wherein the at least one profile of the at least one mmWave link comprises at least one per station (STA) profile of the at least one mmWave link.

9. The wireless MLD of claim 8, wherein the inheritance is not applied to information that is not understandable by an Ultra High Reliability (UHR) STA.

10. The wireless MLD of claim 1, wherein the at least one profile of the at least one mmWave link between the wireless MLD and the second wireless MLD comprises a plurality of profiles of a plurality of mmWave links between the wireless MLD and the second wireless MLD, and wherein a second profile of a first mmWave link between the wireless MLD and the second wireless MLD inherits an element in a first profile of a first mmWave link between the wireless MLD and the second wireless MLD.

11. The wireless MLD of claim 1, wherein the wireless MLD comprises an access point (AP) MLD that comprises a wireless AP, wherein the wireless AP comprises the controller and the wireless transceiver, and wherein the second wireless MLD comprises a non-AP MLD that comprises a non-AP station (STA).

12. The wireless MLD of claim 1, wherein the frame comprises an association response frame.

13. The wireless MLD of claim 1, wherein the non-mmWave link comprises one of a 2.4 Gigahertz (GHz) link, a 5 GHz link, or a 6 GHz link, and wherein the mmWave link comprises a 45 GHz link or a 60 GHz link.

14. The wireless MLD of claim 1, wherein the wireless MLD is compatible with an Institute of Electrical and Electronics Engineers (IEEE) 802.11 protocol.

15. A wireless access point (AP) of an AP multi-link device (MLD) comprising:
a controller configured to generate a frame that comprises a multi-link (ML) information element (IE), wherein the ML IE comprises at least one Per station (STA) profile of at least one millimeter wave (mmWave) link between the AP MLD and a non-AP MLD, wherein the mmWave link comprises a 45 Gigahertz (GHz) link or a 60 GHz link; and
a wireless transceiver configured to transmit the frame to the non-AP MLD through a non-mmWave link between the AP MLD and the non-AP MLD, wherein the non-mmWave link comprises one of a 2.4 GHz link, a 5 GHz link, or a 6 GHz link.

16. The wireless AP of claim 15, wherein the frame further comprises an element that defines Basic Service Set (BSS) information of the non-mmWave link between the AP MLD and the non-AP MLD, and wherein no inheritance of the element is applied to the at least one Per STA profile of the at least one mmWave link.

17. The wireless MLD of claim 16, wherein the controller is further configured to set a non-inheritance subfield of the at least one per STA profile to a predefined value to indicate that no inheritance is applied to the at least one per STA profile.

18. The wireless AP of claim 15, wherein the frame further comprises an element that defines Basic Service Set (BSS) information of the non-mmWave link between the AP MLD and the non-AP MLD, and wherein an inheritance of the element is applied to the at least one profile of the at least one mmWave link.

19. The wireless AP of claim 15, wherein the at least one Per STA profile of the at least one mmWave link between the AP MLD and the non-AP MLD comprises a plurality of Per STA profiles of a plurality of mmWave links between the AP MLD and the non-AP MLD, and wherein a second Per STA profile of a first mmWave link between the AP MLD and the non-AP MLD inherits an element in a first Per STA profile of a first mmWave link between the AP MLD and the non-AP MLD.

20. A method for wireless communications, the method comprising:
at a first wireless multi-link device (MLD), generating a frame that comprises a multi-link (ML) information element (IE), wherein the ML IE comprises at least one profile of at least one millimeter wave (mmWave) link between the first wireless MLD and a second wireless MLD; and
from the first wireless MLD, transmitting the frame to the second wireless MLD through a non-mmWave link between the first wireless MLD and the second wireless MLD.
